(19) United States
(12) Patent Application Publication
(10) Pub. No.: US 2022/0283474 A1
(43) Pub. Date: Sep. 8, 2022

(54) ELECTROPHORETIC FLUID

(71) Applicant: Merck Patent GmbH, Darmstadt (DE)

(72) Inventors: Nathan SMITH, Southampton (GB); Roger KEMP, Winchester (GB)

(21) Appl. No.: 17/635,731

(22) PCT Filed: Aug. 27, 2020
(86) PCT No.: PCT/EP2020/073919

§ 371 Date: Feb. 16, 2022

(30) Foreign Application Priority Data
Aug. 29, 2019 (EP) 19194244.0

(51) Int. Cl. G02F 1/167; G02F 1/1675

(52) U.S. Cl. CPC G02F 1/167; G02F 1/1675; G02F 2001/1678

(57) ABSTRACT

This invention relates to electrophoretic fluids comprising at least two immiscible liquids and black, white and/or coloured particles and/or dyes, and electrophoretic display devices comprising such fluids.

This invention relates to electrophoretic fluids comprising at least two immiscible liquids and black, white and/or coloured particles and/or dyes, and electrophoretic display devices comprising such fluids.

EPDs (Electrophoretic Displays) and their use for electronic paper are known. An EPD generally comprises charged electrophoretic particles dispersed between two substrates, each comprising one or more electrodes. The space between the electrodes is filled with a dispersion medium which is a different colour from the colour of the particles.

In contrast to liquid crystal displays, these types of displays have a paper-like appearance that reduces eye strain and gives a pleasing long-term, readable display. In addition, such displays maintain high contrast in sunlight and are suitable for outdoor applications. They do not require a backlight, and in some cases are bistable, leading to extremely low power requirements.

There are several ways that particles can be used to generate an optical effect for a display. Where a particle-based display requires high reflectivity, this reflectivity comes from a refractive index difference between a particle and the solvent in which it is dispersed. In addition, high reflectivity can be obtained by using a structured substrate with high reflective index (RI) and a solvent with low RI to obtain total internal reflection (TIR). The electrophoretic movement of particles can be used to frustrate this TIR and create a black-white optical change as described in U.S. Pat. Nos. 6,215,920; 6,819,471; and 6,961,167.

There continues to be a demand for alternative and/or improved electrophoretic fluids.

The present invention relates to electrophoretic fluids according to claim 1. Furthermore, the invention relates to electrophoretic displays comprising the new electrophoretic fluids.

Electrophoretic fluids of the invention comprise at least two immiscible liquids selected from hydrocarbon solvents and fluorinated solvents, and black, white and/or colored particles and/or dyes dispersed or dissolved in at least one of the liquids.

This invention concerns a new dual-phase EPD fluid, whereby a hydrocarbon solvent can be used alongside a second, fluorinated solvent. The two solvents must be immiscible.

The hydrocarbon solvent can be any solvents typically used in EPD. Preferably, the hydrocarbon solvents are chosen primarily on the basis of dielectric constant, refractive index, density and viscosity. A preferred solvent choice would display a low dielectric constant (<10, more preferably <5), high volume resistivity (about 10¹⁵ ohm-cm), a low viscosity (less than 5 cst), low water solubility, and a high boiling point (>80° C.). Tweaking these variables can be useful in order to change the behaviour of the final application. Preferred solvents are often non-polar hydrocarbon solvents such as the Isopar series (Exxon-Mobil), Norpar, Shell-Sol (Shell), Sol-Trol (Shell), naphtha, and other petroleum solvents, decalin, tetralin as well as long chain alkanes such as dodecane, tetradecane, decane and nonane. These tend to be low dielectric, low viscosity, and low density solvents.

Preferably, the hydrocarbon solvents are selected from the group consisting of naphtha, decalin, tetralin, dodecane, tetradecane, decane and nonane, especially dodecane.

The fluorocarbon solvent can be present in small amounts, and so some typically undesirable properties for an EPD can be tolerated. For example, dielectric constant can be slightly higher without any significant damage to the display. The fluorinated solvent must be immiscible with the hydrocarbon solvent.

Preferably, the fluorinated solvents are nonpolar and are selected from perfluorinated solvents and partially fluorinated solvents. Preferred solvents are non-polar perfluorinated hydrocarbons, e. g. perfluoro(tributylamine), perfluoro (2-n-butyl hydrofuran), 1,1,1,2,3,4,4,5,5,5,-decafluoropentane, etc. Particularly, commercial non-polar fluorinated solvents such as the Fluorinert® FC or Novec® series from 3M and the Galden® series from Solvay Solexis can be used, e.g. FC-3283, FC-40, FC-43. FC-75 and FC-70 and Novec® 7500 and Galden® 200 and 135. In particular, perfluoro(tributylamine) and Novec® 7500 can be used.

The black, white and coloured particles can be dispersed in one of either solvent phase and should preferably remain stable in the system when the solvents are mixed. All particles typically incorporated in EPDs can be used in the fluids of the invention. Preferably, particles described in WO 2010/089060, WO 2010/089057, WO 2011/154103, WO 2011/154104, WO 2012/019704, WO 2013/026519, WO 2013/079146, WO 2013/170935, WO 2015/082047, and WO 2015/082048 can be used.

Different additives can be added to either phase to improve charging properties and/or solvent movement. Typical additives to improve the stability of the electrophoretic fluid (either by steric stabilisation or by use as a charging agent) are known to experts in the field and include (but are not limited to) the Brij, Span and Tween series of surfactants (Aldrich), Infineum surfactants (Infineum), the Solsperse, Ircosperse and Colorburst series (Lubrizol), the OLOA charging agents (Chevron Chemicals) and Aerosol-OT (Aldrich). Preferably, AOT and OLOA are used for the hydrocarbon phase. Preferably, fluorinated surfactants are used in combination with the fluorinated solvents Such are known to experts in the field and include (but are not limited to) the Disperbyk® series by BYK-Chemie GmbH, Solsperse® and Solplus® range from Lubrizol, RM and PFE range from Miteni, EFKA range from BASF, Fomblin® Z, and Fluorolink® series from Solvay Solexis, Novec® series from 3M, Krytox® and Capstone® series available from DuPont. Preferably, Krytox® surfactants are used for the fluorinated phase.

Preferred are poly(hexafluoropropylene oxide) polymeric surfactants with a monofunctional carboxylic acid end group and a weight-average molecular weight Mw between 1000 and 10000, most preferred between 3000 and 8000 and especially preferred between 5000 and 8000. Most preferred is Krytox® 157 FSH. Further suitable Krytox® surfactants comprise the following end groups: methyl ester, methylene alcohol, primary iodide, allyl ether or a benzene group.

Any other additives to improve the electrophoretic properties can be incorporated provided they are soluble in the formulation medium, in particular thickening agents or polymer additives designed to minimise settling effects.

In a TIR mode the fluorinated solvent acts as a mobile low RI region which can be displaced by the higher RI solvent from the surface of the substrate under application of a voltage. Black, white or coloured particles can be dispersed in the hydrocarbon to generate an optical effect.

In a particle-based reflective system, reflective particles can be dispersed in the fluorinated system, improving their apparent reflectivity, whilst absorbing particles or dyes can be dispersed or dissolved in the hydrocarbon. The two solvents must be completely immiscible, and this ensures perfect separation between the white particles and the absorbing particles (or dye).

In addition, the system could be made bistable by applying Teflon layers to the substrates. The surface interactions between the fluorinated solvent and the fluorinated surface prevent diffusion of the solvent and enable the voltage to be removed whilst leaving the solvent in position.

Finally, the fluorinated solvent need only be present in smaller amounts, reducing cost and environmental effects. More materials are readily available for hydrocarbon based solvent phase, whilst still keeping the advantages of using a low RI solvent where needed.

The following further advantages can be achieved with the electrophoretic fluids of the invention:
Increased apparent reflectivity of white and reflective colour particles;
Improved particle separation in dual particle EPD;
Mobile solvent phase enables TIR switching;
Enhanced TIR in TIR mode EPD
Improved bistability;
Less environmental concerns and reduced costs by use of less fluorinated solvents and additives;

In both the case of reflective particles, or reflective TIR substrates, the reflectivity is reliant on a high RI material, such as TiO₂ particles, or a high RI polymer structured substrate, surrounded by a continuous phase with a lower RI. Preferably, to maximise the reflectivity, the refractive index difference between particle/substrate, and the continuous phase needs to be as large as possible, and hence the RI of the continuous phase needs to be as low as possible.

The new electrophoretic fluids comprise bi-phasic systems consisting of a hydrocarbon, and a fluorocarbon, whereby one phase may be displaced by the other onto an electrode. This can be used to generate a temporary, reversible RI change at the electrode for TIR applications, or give enhanced reflectivity to a white particle in a fluorocarbon solvent, allowing a second particle dispersed in a hydrocarbon solvent to be independently controlled by conventional EPD methods, and enhanced reflectivity in the white state.

In addition, the RI of the HC phase can be matched to the black/coloured particle, to give more intense black or improved colour saturation, without any accompanying effect on the white state, because the white state reflectivity is independent of the RI of the HC continuous phase.

The solvents and additives used to disperse the particles are not limited to those used within the examples of this invention and many other solvents and/or dispersants can be used. Suitable solvents and dispersants for electrophoretic displays can be found in existing literature, in particular in WO 99/10767 and WO 2005/017046. The Electrophoretic fluid is then incorporated into an Electrophoretic display element by a variety of pixel architectures, such as can be found in C. M. Lampert, Displays; 2004, 25(5) published by Elsevier B.V., Amsterdam.

The electrophoretic fluid may be applied by several techniques such as inkjet printing, slot die spraying, nozzle spraying, and flexographic printing, or any other contact or contactless printing or deposition technique.

Electrophoretic displays comprise typically, the electrophoretic display media in close combination with a monolithic or patterned backplane electrode structure, suitable for switching the pixels or patterned elements between the optical states or their intermediate states.

The electrophoretic fluids according to the present invention are suitable for all known electrophoretic media and electrophoretic displays, e.g. flexible displays, TIR-EPD (total internal reflection electrophoretic devices), one particle systems, two particle systems, dyed fluids, systems comprising microcapsules, microcup systems, air gap systems and others as described in C. M. Lampert, Displays; 2004, 25(5) published by Elsevier B.V., Amsterdam.

Examples of flexible displays are dynamic keypads, e-paper watches, dynamic pricing and advertising, e-readers, rollable displays, smart card media, product packaging, mobile phones, lab tops, display card, digital signage, shelf edge labels, etc.

The following examples explain the present invention in greater detail without restricting the scope of protection. In the foregoing and in the following examples, unless otherwise indicated all parts and percentages are by weight (wt).

### EXAMPLES

Dual-phase formulations are synthesised and analysed using a Nikon LV100 Eclipse microscope at 5× magnification. A test cell setup consisting of 500 micron spaced interdigitated finger electrodes is used, with a spacer of 15 microns applied to the cell, and a plain glass slide placed on top of the substrate to ensure even filling of the cell. The cell is imaged with 0V applied. A DC 180V (field=0.36V/micron) voltage is applied between the electrodes, and the movement of particles/solvent is observed and imaged. Further, a DC 250V (field=0.50V/micron) voltage is applied between the electrodes, and the movement of particles/solvent is observed and imaged.

### Example 1: Dual Phase Solvent Mixture—Charge Independent

0.95 g of Dodecane is mixed with 0.38 g of Novec® 7500 and filled into a test cell. Images are taken at 0V, 180V and 250V. At zero voltage the Novec 7500 has no alignment with the electrodes. When 180V is applied, the Novec® 7500 shows an attraction to the electrodes. At 250V the electrodes are completely covered by the Novec® 7500, regardless of polarity (both −ve and +ve electrodes are covered with Novec® 7500).

### Example 2: Dual Phase Solvent Mixture+Particles—Charge Controlled

0.105 g of black polymer particles are dispersed in 1.245 g of dodecane along with 0.02 g of Infineum E and added to 0.709 g of Novec® 7500. The resultant mixture is filled into a test cell. Images are taken at +250V and −250V. The solvent can be controllably displaced and aligned with the desired electrode. The particles also show electrophoretic movement and are attracted to the opposite electrode.

### Example 3: Dual Phase Solvent Mixture+Dual Particle Sets—Charge Controlled

In this example, white TiO₂ particles are dispersed in the fluorinated phase with Krytox®, and black dyed PMMA particles are dispersed in the hydrocarbon phase with Infineum E. The particles cannot be mixed as they are in different solvent phases. This leads to very defined separation of the black and white particles.

1.-8. (canceled)

9. An electrophoretic fluid comprising at least two immiscible liquids and black, white and/or colored particles and/or dyes dispersed or dissolved in at least one of the liquids.

10. The electrophoretic fluid according to claim 9, wherein the immiscible liquids are selected from hydrocarbon solvents and fluorinated solvents.

11. The electrophoretic fluid according to claim 9, wherein hydrocarbon solvents are selected from the group consisting of naphtha, decalin, tetralin, dodecane, tetradecane, decane and nonane.

12. The electrophoretic fluid according to claim 9, wherein fluorinated solvents are nonpolar and are selected from perfluorinated solvents and partially fluorinated solvents.

13. The electrophoretic fluid according to claim 9, wherein black, white and/or coloured particles and/or dyes are absorbing particles or dyes and are dispersed or dissolved in the hydrocarbon solvent.

14. The electrophoretic fluid according to claim 9, wherein the black, white and/or coloured particles are reflective particles and are dispersed in the fluorinated solvents.

15. An electrophoretic display device comprising an electrophoretic fluid according to claim 9.

16. The electrophoretic display device according to claim 15, wherein the electrophoretic fluid is applied by a technique selected from inkjet printing, slot die spraying, nozzle spraying, and flexographic printing, or any other contact or contactless printing or deposition technique.
